(19) United States
(12) Patent Application Publication
(10) Pub. No.: US 2004/0011850 A1
(43) Pub. Date: Jan. 22, 2004

(54) Centrifugal apparatus for removing excess solder

(76) Inventors: Arthur Allan Bayot, Baguio City (PH); Ferdinand Arabe, Baguio City (PH)

Correspondence Address: TEXAS INSTRUMENTS INCORPORATED, P O BOX 655474, M/S 3999, DALLAS, TX, 75265

(21) Appl. No.: 10/200,640

(22) Filed: Jul. 22, 2002

(51) Int. Cl. B23K 5/22; B23K 20/08; B23K 31/02

(52) U.S. Cl. 228/19; 228/33; 228/223

(57) ABSTRACT

Apparatus and methods for removing excess solder from connections on electrical circuits is disclosed. The apparatus and methods comprise providing an enclosure in which the circuits with excess solder are heated to a temperature above the melting point of the excess solder. There is also provided a clamp or mounting device for securing the electrical circuits with the excess solder such that they can be spun up to a sufficient rotating speed to cause the excess solder to be spun off the connections by centrifugal force. The enclosure includes an annular solder collecting pan for collecting the excess solder as it is removed from the circuit board.

### FIELD OF THE INVENTION

This invention relates generally to apparatus and methods for removing solder ball connections from a backside of a circuit, such as a flip-chip package having components attached by solder connections (such as for example solder ball connections), and more specifically, to methods and apparatus for using heat to soften or melt the solder and centrifugal force to remove the molten solder from the connections. The invention is also useful for reworking such circuits having one or more defects related to excessive solder connections.

### BACKGROUND OF THE INVENTION

Circuit elements are often attached to a printed circuit board or circuit by solder ball connections. As will be appreciated by those skilled in the art, if one or more of the solder ball connections receives too much solder or somehow the solder is smeared or otherwise disturbed before the solder hardens, a solder connection may be created between two or more adjacent solder ball connections thereby causing a short and subsequent rejection of the circuit as being defective. Such defects historically have resulted in a yield ration of about 99.2%, which although a seemingly high yield rate, still results in thousands of dollars of rejects every day. Increasing the yield rate by as little as a half of a point would typically cut the losses due to such defective solder ball connections to less than half of that presently experienced. Therefore, removal of excess solder from the connections can be very advantageous. However, presently available techniques for removing excess solder typically involve some type of physical contact or scraping between the connections with excess solder and a hard or sharp edge to mechanically scrape the excess solder from the connections, such as for example as taught in U.S. patent application (TI-32669) Ser. No. 10/034,341 filed Dec. 28, 2001 and assigned to the same assignee as the present invention. The mechanical scraping can cause damage to the circuit connections. The present invention eliminates the mechanical scraping which reduces physical damage to the connection and thereby further increases yields.

### SUMMARY OF THE INVENTION

In the preferred embodiment, the present invention provides methods and apparatus for removing excess solder from electrical connections made on electrical circuit boards. The methods and apparatus comprise a primary enclosure which houses or encloses a centrifugal solder-removing apparatus. The apparatus further includes a heating source to raise the temperature of the solder connections (such as solder ball connections) above their melting points, and a holding or clamping device for securing or mounting the circuit boards so they can be rapidly rotated as the circuits are subjected to centrifugal force. By locating the circuits such that they are substantially perpendicular to the centrifugal force, the solder will spin away or sling off the circuit by centrifugal force. Although an electrical resistance heater may be the most convenient to use, any suitable heat source is satisfactory so long as it can provide enough heat to raise the temperature of the solder above its melting point.

Also as discussed above, the circuit is first attached or secured to a support device such as a support plate and then heated to a sufficient level so that the solder ball connections begin to melt. The apparatus then spins the circuits with the melted solder connections to create a centrifugal force sufficient to sling or remove the solder. The excess solder is collected in an annular collecting pan or container located around the perimeter of the primary enclosure.

According to a preferred embodiment, a flux material such as WS-600, commercially available from the Alphametals Corporation in Singapore, is applied to the solder connections before the heating and spinning processes. To assure full removal of the solder ball connections, it is advisable to repeat the heating and spinning process at least one more time.

### BRIEF DESCRIPTION OF THE DRAWINGS

The above-mentioned features as well as other features of the present invention will be clearly understood from the consideration of the following description in connection with accompanying drawings in which:

FIG. 1 shows the backside of a circuit board having circuit elements attached by solder ball connections;

FIG. 1A shows a circuit similar to FIG. 1 wherein one or more of the solder ball connections are defective in that they are shorted to an adjacent connection;

FIG. 2 is a side view of the centrifugal apparatus of the present invention;

FIG. 3 is a top view of first and second embodiments of the invention; and

FIG. 4 is a flow diagram illustrating the method of the present invention.

### DESCRIPTION OF PREFERRED EMBODIMENTS

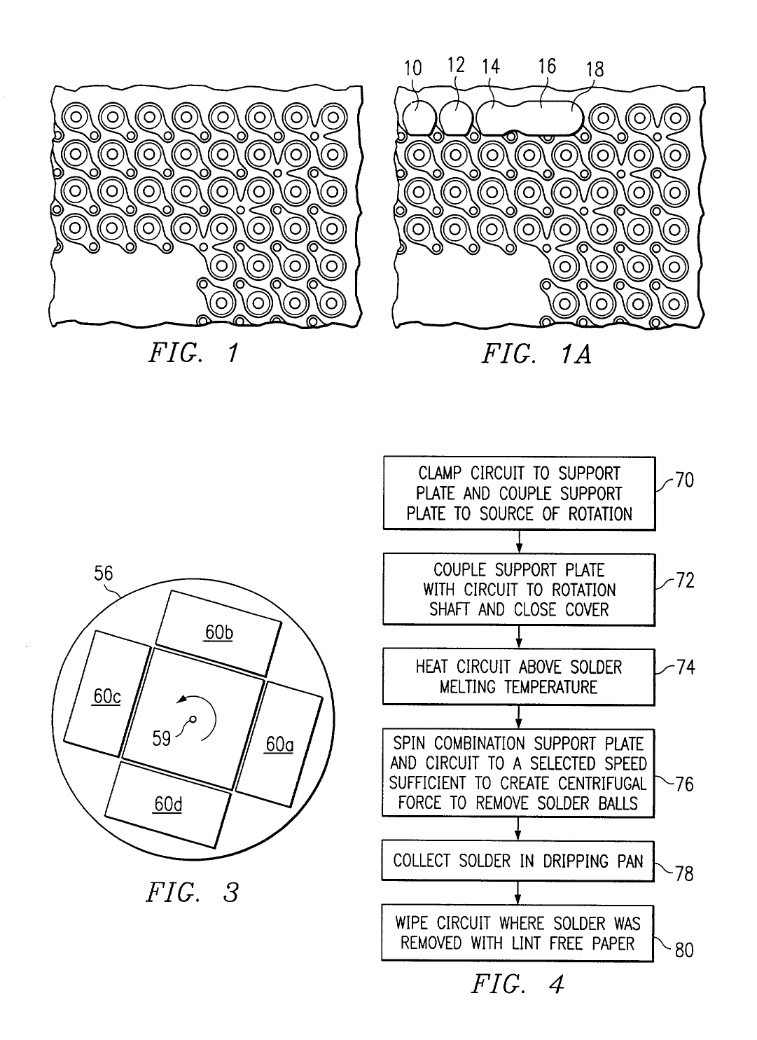

Referring now to FIG. 1, there is illustrated the backside of a circuit which includes a multiplicity of acceptable solder ball connections (i.e., no defective connections). FIG. 1A, on the other hand, shows a similar unit which has two questionable solder ball connections, 10 and 12, which are oversized, and although they do not appear to be shorted to any other connections, may still be classified as defective. There are also three additional solder ball connections, 14, 16 and 18, which are clearly defective in that the solder for the three connections has been allowed to flow or merge to the point that the solder for the connection points 14, 16 and 18 are all shorted together. Therefore, the circuit or flip-chip package of FIG. 1A is clearly unacceptable and must be rejected, and thus will have negative effect on the yield rate of the process.

However, if the excess solder can be removed, or if substantially all of the solder making up the solder ball connections on the defective package can be removed, another attempt can be made to provide the chip with new solder ball connections which do not include any defective connections. Testing and evaluation of the rework process of this invention indicates that the process is sufficiently effective to raise the yield rate from 99.2% to 99.7% which results in significant dollar savings.

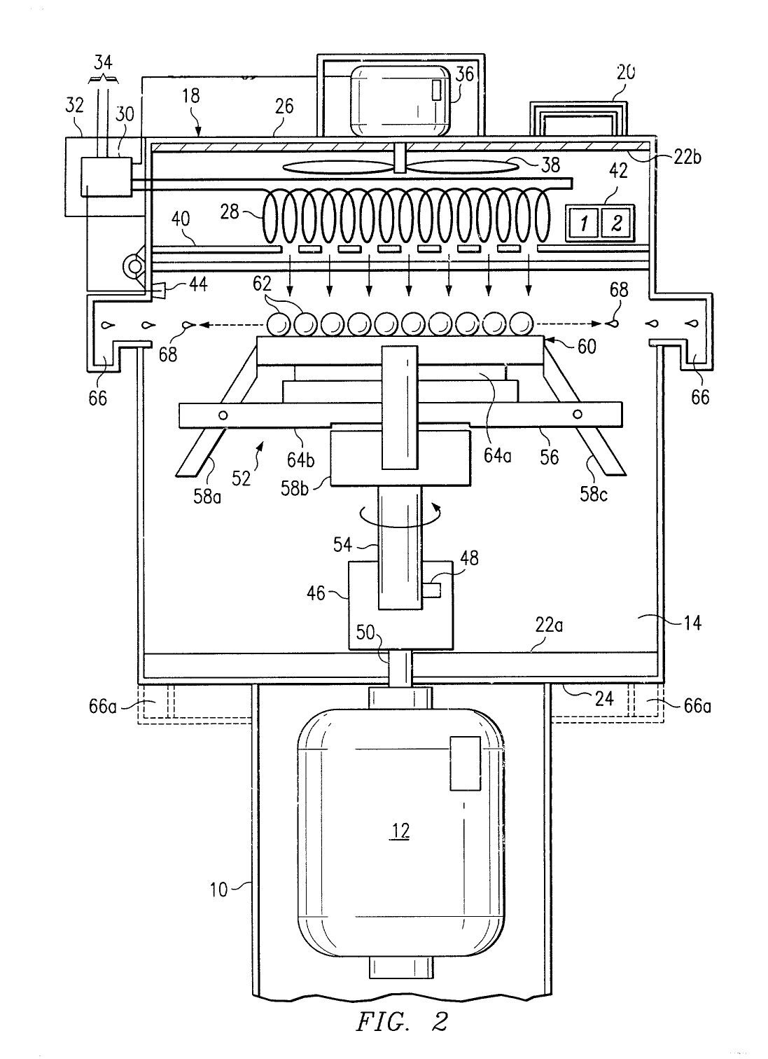

Referring now to FIG. 2, there is shown a side sectional view of an apparatus for carrying out the teachings of the present invention. As shown, there is a support base 10 which also serves as a protective housing to a drive source, such as for example an electrical motor 12. A primary enclosure 14 is supported by support base 10 and will preferably be round or have a circular cross section. Enclosure 14 includes cover 18, such as a hinged cover with a handle 20. To provide more efficient heating and temperature control, there is also included a layer of insulation 22a at the bottom 24 of enclosure 14. Also shown is a layer of insulation 22b at the top portion 26 of cover 18. Although shown at the inside of enclosure 14, it will be appreciated that the insulation layers 22a and 22b could be located on the outside of bottom 22 and top 26. Likewise, additional insulation could be included at either the inside or outside of the side walls of enclosures 14. Referring to cover 18, there is also shown an electrical heating unit or resistance coil 28 which is coupled to a switching circuit 30 located in control box 32 attached to cover 18. Control box 32 is also shown receiving power from a power source (not shown) on wires 34 which provides the power for the resistance heating coil 28 and a second electrical motor 36. As shown, motor 36 provides power to a fan 38 for moving heated air from the cover area of the enclosure 14 through a baffle plate or grid 40 into the interior of enclosure 14. There is also shown a temperature and timer indicator 42 attached to cover 18, and a temperature detection circuit 44 connected to switching circuit 30 in control box 32 for maintaining a selected temperature within enclosure 14.

Although control box 32 and temperature and timer indicator 42 are shown as being attached to cover 18 of enclosure 14, it will be appreciated that these items could be mounted anywhere on enclosure 14 or support base 16. Alternately, these items could be mounted on a console or control board completely separate from the enclosure.

As discussed above, enclosure 14 could be substantially any selected cross section, although a circular cross section is preferred. There is an adapter coupling 46 with a quick disconnect spring lock attached to the rotating shaft 50 of power source or motor 12. The adapter coupling 46 and spring lock 48 allow for rapidly attaching and removal of the rotating mounting apparatus 52 at mounting shaft 54. The rapid attaching and removal of a mounting apparatus at adapter coupling 45 allows different types of mounting apparatus to be used with the invention. Thus, a mounting apparatus for a single large circuit as illustrated could be coupled to the drive source 12 or alternatively, the mounting apparatus 52 could be designed to receive a multiplicity of smaller circuit boards such as will be discussed hereinafter with respect to the top schematic view of FIG. 3.

For illustration purposes only, mounting apparatus 52 includes a plate member 56 with clamp members 58a, 58b and 58c used to secure a circuit board 60 having a multiplicity of solder balls 62 used for making connecting electrical components to circuit board 60. It will be appreciated that solder balls 62 are shown greatly enlarged to illustrate the process of the invention. There is also shown spacer members 64a and 64b as part of the plate member 56 to raise the vertical position of the circuit board 60, and consequently, the multiplicity of solder balls 62 on circuit 60 to a level in line with an opening to annular collecting solder pan 66.

Thus, according to the invention, the circuit board 60 is mounted to the plate member 56 by clamps 58a, 58b and 58c. For the typical square or rectangular circuit boards, there will also typically be a fourth clamp 58d, which is not visible in FIG. 2. Of course, other methods of securing or attaching the circuit board 60 to plate number 56 may be used. It is only necessary that the method secure the circuit board(s) sufficiently to withstand the centrifugal forces that will be applied. It is also, of course, advantageous to balance the rotating plate member 56 and circuit board 60 to avoid undue stress and wear on the equipment.

Once the circuit board is securely mounted to the plate member 56, the cover 18 is closed and the heat source 28 and fan 36 are turned on to raise the temperature of the interior of enclosure 14 and, more specifically, to raise the circuit board to a sufficient temperature to begin melting the solder used in the solder ball connection 62. Although this temperature may vary depending on the melting temperature of the solder used on the circuits, a temperature range of between about 190° C. and 250° C. will be adequate to melt most commercially available solder. A typical temperature for melting solder is about 183° C. To assure consistent melting and proper solder bonding to the component levels and circuit board traces, a flux such as WS-600 flux by the Alphametals Corporation may be applied to the solder connections before the heating step. Although the electrical resistance heating coil 28 is a simple and easy approach for providing heat to the enclosure, it will be appreciated that any type of heating source that can raise the temperature of the solder to its melting point can be used.

Once the enclosure temperature is raised to a selected level, the rotating drive source 12 is turned as to start rotating or spinning plate member 56. As will be appreciated, the faster the apparatus and circuit board spins, the greater centrifugal force that will be applied to the melted solder on the circuit board connections. The centrifugal force will eventually be sufficient to cause the excess solder of the solder ball connection 62 to move away or to sling off the circuit board in a radial direction as indicated by solder drops 68. In the embodiment shown, the drops of solder 68 are slung into the annular collecting pan 66 such that the solder can be recovered and recycled.

According to another embodiment, the collecting pan 66a may be positioned at the bottom of enclosure 14. In this embodiment, the solder would hit against the enclosure sidewalls and drop to the collecting pan 66a. If this embodiment is used, care must be taken to assure the solder does not build up on the inside walls of the enclosure.

It is also important to understand that a solder ball connection along the center of rotation will not experience any centrifugal force, and therefore, care must also be taken to assure there are no connections with excessive solder in line with the center of rotation. This is easily accomplished when several circuits are arranged around the center of rotation 59 as indicated by circuits 60a, 60b, 60c and 60d shown in FIG. 3. It should also be appreciated that although four circuits are shown in FIG. 3, there could be two, three or significantly more than four circuits mounted to plate 56.

FIG. 4 is a flowchart showing method steps of the invention. As shown, the cover 18 of the centrifugal enclosure 16 is opened and the circuit(s) selected for solder removal are clamped to the support device or spin plate 56 and the combination spin plate 56 and circuit(s) 60 are attached or coupled to shaft 50 of motor 12. This is shown as steps 70 and 72 of FIG. 4. The cover 18 is closed and heat is applied to the circuit, such as for example, by heat coil 28 and fan 38 as shown in step 74. Once the inside temperature of the chamber reaches a selected temperature which is above the solder melting point, the spin plate 56 with the clamped circuit(s) 60 begin spinning around axis or shaft 50 and spins up to a rotation speed of about 1500 RPM as shown at step 76. This speed has been found sufficient to generate the necessary centrifugal force to sling or remove the excess solder from the circuit boards 60 such that it is collected in the solder collecting pan 66 (or 66a) as shown in step 78. It will be also appreciated that according to a preferred embodiment, solder flux material such as WS-600, commercially available from the Alphametals Corporation of Singapore, is applied to the solder ball connections prior to them being placed into the centrifugal apparatus. Also according to one embodiment, wiping with a lint-free paper as shown in step 80 cleans up the back of the circuit where the solder ball connections have been removed.

Thus, there has been described unique apparatus and methods of this invention for reworking solder ball connections on a circuit. However, although the invention has been described with respect to specific methods and apparatus, it is not intended that such specific references be considered limitations upon the scope of the invention except as is set forth in the following claims.

What is claimed is:

1. Centrifugal apparatus for removing solder ball connections from electronic circuits comprising:
an enclosure;
a mounting device located in said enclosure for mounting at least one circuit having one or more solder connections;
a heat source for heating said at least one circuit to a temperature sufficient to melt solder on said one or more connections; and
a rotating source for spinning said combination mounting device and said at least one circuit around an axis to a speed sufficient to sling or remove said excess solder from said one or more connections by centrifugal force.

2. The centrifugal apparatus of claim 1 wherein said mounting device supports at least two circuits at locations radially spaced from said axis such that solder connections on said one or more circuits are subjected to centrifugal force.

3. The apparatus of claim 1 wherein said heat source includes an apparatus for moving air to direct heat on to said one or more circuits.

4. The apparatus of claim 1 further comprises an annular solder collecting pan spaced radially from said mounting device such that melted excess solder slung from said circuits travels to and collects in said annular collecting pan.

5. The apparatus of claim 1 wherein said enclosure is heated to a temperature above about 183° C.

6. The apparatus of claim 1 wherein said enclosure is heated to a temperature of between about 190° C. and 250° C.

7. The apparatus of claim 2 wherein said enclosure is heated to a temperature of between about 190° C. and 250° C.

8. The apparatus of claim 1 wherein said at least one circuit spins up to a rotation speed of about 1500 RPM.

9. The apparatus of claim 2 wherein said at least one circuit spins up to a rotation speed of about 1500 RPM.

10. A method of reworking a circuit unit having one side with a multiplicity of exposed solder ball connections comprising the steps of:
heating a circuit unit having at least one connection with excess solder to a temperature sufficient to melt solder on said at least one connection; and
subjecting said circuit unit to sufficient centrifugal force to remove said excess solder from said at least one connection.

11. The method of claim 10 and further comprising the steps of applying flux to said at least one connection with excess solder prior to said heating step.

12. The method of claim 11 wherein said step of applying flux comprises applying WS-600 flux.

13. The method of claim 10 wherein said heating step comprises heating said circuit unit to a temperature above 183° C.

14. The method of claim 11 wherein said heating step comprises heating said circuit unit to a temperature above 183° C.

15. The method of claim 10 wherein said heating step comprises heating said circuit unit to a temperature of between about 190° C. and 250° C.

16. The method of claim 11 wherein said heating step comprises heating said circuit unit to a temperature of between about 190° C. and 250° C.

17. The method of claim 10 wherein said subjecting step comprises spinning said circuit unit up to a speed of about 1500 RPM.

18. The method of claim 11 wherein said subjecting step comprises spinning said circuit unit up to a speed of about 1500 RPM.

19. The method of claim 15 wherein said subjecting step comprises spinning said circuit unit up to a speed of about 1500 RPM.

20. The method of claim 10 further comprising wiping said at least one connection having excess solder with a lint-free paper after said subjecting step.
